(19) United States
(12) Patent Application Publication
(10) Pub. No.: US 2025/0156124 A1
(43) Pub. Date: May 15, 2025

(54) INFORMATION PROCESSING APPARATUS CAPABLE OF PROPERLY PERFORMING RESERVATION PRINTING, METHOD OF CONTROLLING SAME, AND STORAGE MEDIUM

(71) Applicant: CANON KABUSHIKI KAISHA, Tokyo (JP)

(72) Inventor: SHINYA SUZUKI, Chiba (JP)

(21) Appl. No.: 18/945,928

(22) Filed: Nov. 13, 2024

(30) Foreign Application Priority Data
Nov. 15, 2023 (JP) 2023-194301

(51) Int. Cl. G06F 3/12

(52) U.S. Cl. CPC G06F 3/1205; G06F 3/1253; G06F 3/1285

(57) ABSTRACT

An information processing apparatus that manages a print job to be transmitted to a printer using a general-purpose printer driver so as to make it possible to properly perform reservation printing on a user-by-user basis, in the printer. User information required by a printer which is communicably connected to the information processing apparatus directly or via a cloud is set and stored. Print data for executing a print job in the printer is generated. The stored user information is acquired when the print job is executed by the printer. The generated print data and the acquired user information are transmitted to the printer.

### BACKGROUND OF THE INVENTION

### Field of the Invention

The present invention relates to an information processing apparatus that is capable of properly performing reservation printing, a method of controlling the same, and a storage medium.

### Description of the Related Art

A general-purpose printer driver using an industry standard protocol, such as the Internet Printing Protocol (IPP), includes a local printer driver that is directly connected to a printer and a cloud printer driver that transmits print data to a cloud print service. The general-purpose printer driver can communicate with printers of a plurality of printer vendors. Therefore, a user can transmit print data to the local printer or the cloud print service by using the general-purpose printer driver even without installing a printer driver specific to a vendor in an information processing apparatus, such as a personal computer (PC) or smartphone, which is handled by himself/herself.

However, the general-purpose printer driver is limited in settable print conditions and functions, so as to make the same applicable to printers of a variety of vendors, for use. In view of this, Japanese Laid-Open Patent Publication (Kokai) No. 2021-124791 proposes a technique for installing an application compatible with a printing apparatus registered in a cloud print service in a terminal (information processing apparatus) used by a user without bothering the user. With this, the user can use a print setting user interface (UI) and a print job edit function, which are unique to a vendor.

There is a printer that has a reservation printing function and has a function of performing job management on a user-by-user basis in reservation printing. When a user designates a user name to be used for logging into the printer and transmits a print job to the printer from a terminal, the print job and the user name (user information) attached to the print job are stored in the printer. After that, when the user logs into the printer, only the print jobs of his/her own, which are stored in the printer, are displayed on a display of the printer. Therefore, the user can securely obtain a print product by selecting a desired print job from the displayed print jobs and executing the selected print job.

However, the general-purpose printer driver does not allow designation of a user name, and a user name determined by an operating system (OS) of a terminal used by the user is attached to a print job. As a result, the user name managed by the printer and the user name attached to the print job can be different from each other, causing a situation where even when the user has logged in the printer, the user cannot select a desired print job. In the technique described in Japanese Laid-Open Patent Publication (Kokai) No. 2021-124791, although it is possible to set a print job by making full use of the functions of the printer, the above-described problem is not mentioned.

### SUMMARY OF THE INVENTION

The present invention provides an information processing apparatus that manages a print job to be transmitted to a printer, by using a general-purpose printer driver, such that the printer can properly perform reservation printing on a user-by-user basis.

In a first aspect of the present invention, there is provided an information processing apparatus, including at least one processor, and a memory coupled to the at least one processor storing instructions that, when executed by the processor, cause the processor to function as: a setting unit configured to set user information required by an image forming apparatus which is communicably connected directly or via a cloud, a storage unit configured to store user information set by the setting unit, a generation unit configured to generate print data for executing a print job in the image forming apparatus, an acquisition unit configured to acquire the user information from the storage unit when the print job is executed by the image forming apparatus, and a transmission unit configured to transmit the print data and the user information acquired by the acquisition unit to the image forming apparatus.

In a second aspect of the present invention, there is provided a method of controlling an information processing apparatus communicably connected to an image forming apparatus directly or via a cloud, including setting user information required by the image forming apparatus, storing the user information in a storage unit, generating print data associated with a print job to be executed by the image forming apparatus, acquiring the user information from the storage unit, and transmitting the print data and the user information to the image forming apparatus.

According to the present invention, it is possible to manage a print job to be transmitted to a printer, by using a general-purpose printer driver, such that the printer can properly perform reservation printing on a user-by-user basis.

Further features of the present invention will become apparent from the following description of exemplary embodiments (with reference to the attached drawings).

### BRIEF DESCRIPTION OF THE DRAWINGS

FIG. 1 is a diagram showing a schematic configuration of a printing system according to embodiments.

FIGS. 2A to 2D are diagrams showing respective hardware configurations of apparatuses forming the printing system.

FIG. 3 is a diagram useful in explaining an installation sequence for a print setting-extending application.

FIG. 4 is a diagram showing an example of a printer information display screen displayed on a client terminal.

FIG. 5 is a diagram showing an example of capabilities information held by a printer.

FIGS. 6A and 6B1-6B2 are diagrams each showing an example of device capabilities information held by the client terminal.

FIG. 7 is a diagram showing an example of an extension setup information file.

FIG. 8 is a sequence diagram of a print data transmission process performed by the client terminal.

FIG. 9 is a diagram showing an example of a print setting screen displayed on the client terminal.

FIGS. 10A and 10B are diagrams each showing an example of an extended print setting screen.

FIG. 11 is a flowchart of a process performed in a step S817.

FIG. 12 is a diagram showing an example of a registration state of print jobs in a database of the printer.

FIG. 13 is a flowchart of a print process performed by the printer.

FIG. 14 is a diagram showing an example of a job list displayed on a display section in a step S1304.

FIG. 15 is a flowchart of a user interface (UI) starting process performed in a step S811 in a second embodiment.

### DESCRIPTION OF THE EMBODIMENTS

The present invention will now be described in detail below with reference to the accompanying drawings showing embodiments thereof.

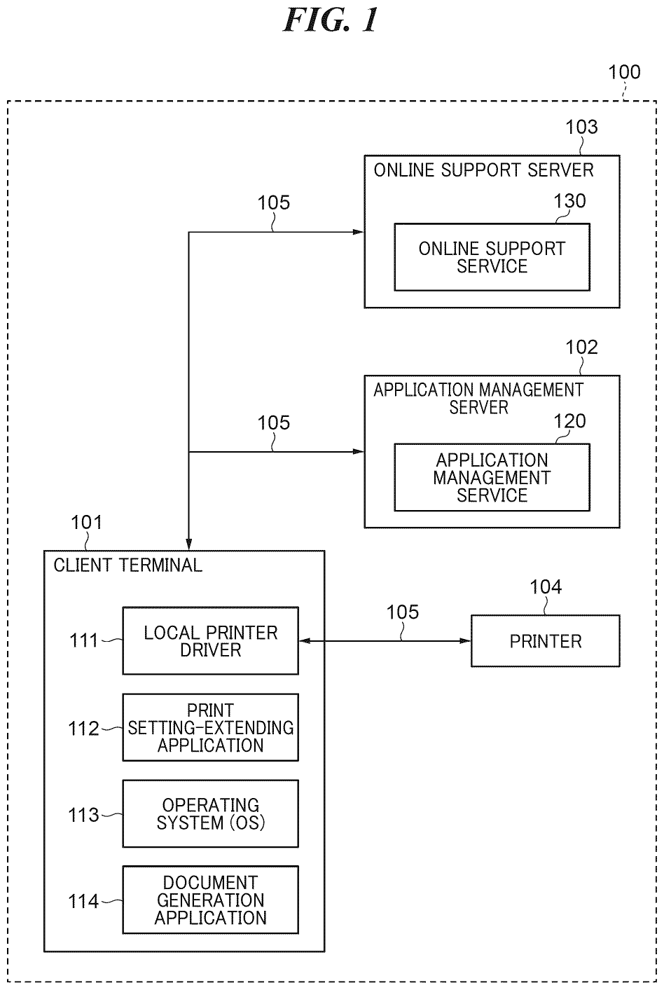

FIG. 1 is a diagram showing a schematic configuration of a printing system 100 according to embodiments. The printing system 100 is formed by communicably connecting a client terminal 101 to an application management server 102, an online support server 103, and a printer 104 via a network 105. In the following description, the application management server 102 is abbreviated as the management server 102, and the online support server 103 is abbreviated as the support server 103.

Note that although one client terminal 101 and one printer 104 are illustrated in FIG. 1, these each can be provided in plurality. Further, each of the management server 102 and the support server 103 can be a server system formed by a plurality of information processing apparatuses, and with this configuration, it is possible to distribute the processing load to the plurality of information processing apparatuses. On the other hand, the management server 102 and the support server 103 can be configured such that they are virtually separated in a physically single information processing apparatus.

Although the network 105 is a wide area network (WAN), such as the Internet, this is not limitative, but the network 105 can be a network limited in communication range, such as an intracompany local area network (LAN).

The client terminal 101 is an information processing apparatus operated by a user, such as a laptop-type PC, a tablet PC, or a smartphone. The client terminal 101 can start and execute desired application software (hereinafter abbreviated as the application) selected by the user. The client terminal 101 holds a local printer driver 111, a print setting-extending application 112, an operation system (OS) 113, and a document generation application 114, as the applications.

Note that the state of the client terminal 101 appearing in FIG. 1 shows a state in which processes according to sequences and flowcharts, described hereinafter, are completed, and a print job including user information can be transmitted to the printer 104. Details of the variety of applications held by the client terminal 101 will be additionally described hereinafter when describing a variety of processes performed in the printing system 100.

The printer 104 receives print data generated by the local printer driver 111 in the client terminal 101 via the network 105, converts the received print data to image data, and performs printing (image formation) on a recording medium, such as a sheet.

The management server 102 is an information processing apparatus holding (storing) an application management service 120 (hereinafter abbreviated as the management service 120) as software that holds and manages a variety of applications. The management server 102 executes the management service 120, receives identification information of an application and a download request from the client terminal 101, and transmits the application identified based on the received identification information to the client terminal 101.

The support server 103 is an information processing apparatus storing an online support service 130 (hereinafter abbreviated as the support service 130) as software for providing information for extending functions of the client terminal 101 to the client terminal 101.

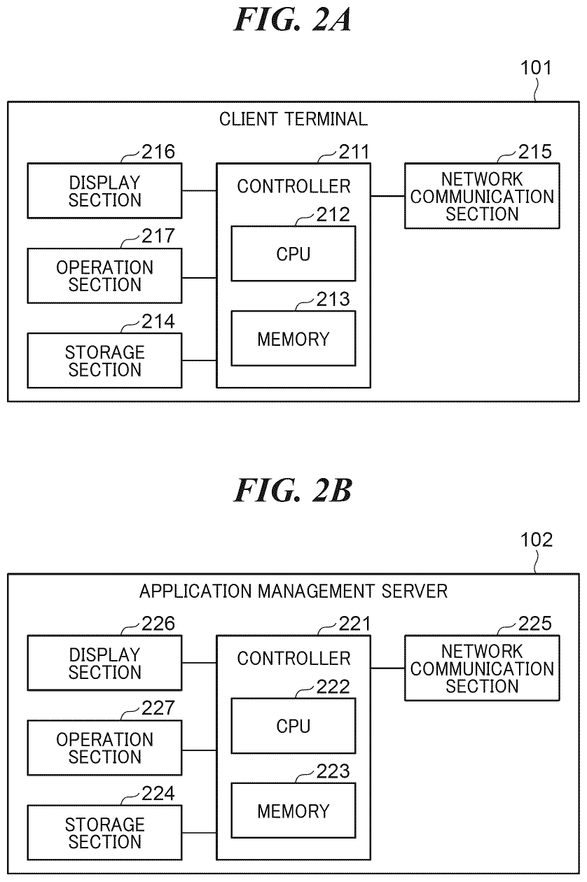

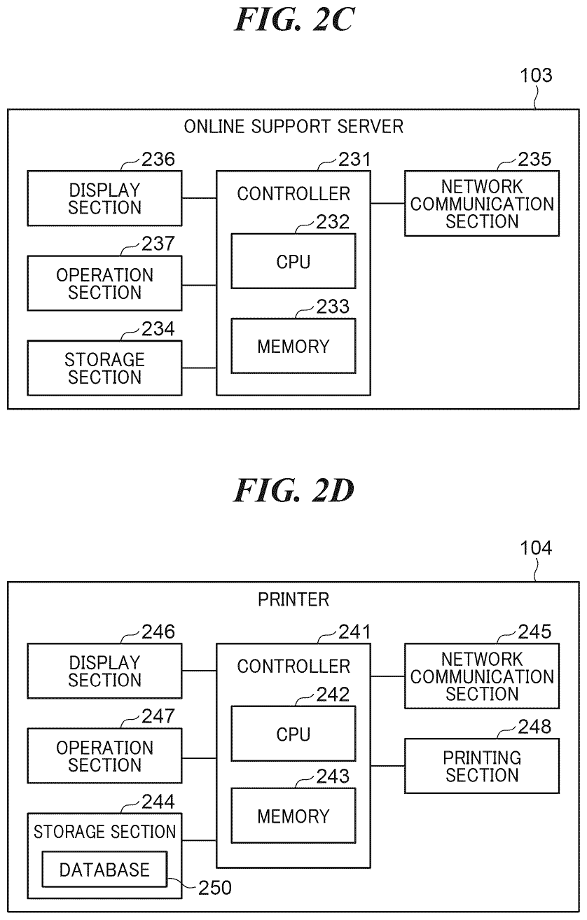

FIGS. 2A to 2D are diagrams showing respective hardware configurations of the apparatuses forming the printing system 100. FIG. 2A is a block diagram showing the hardware configuration of the client terminal 101. The client terminal 101 includes a display section 216, an operation section 217, a storage section 214, a controller 211, and a network communication section 215.

The storage section 214 is a storage device, such as a hard disk drive (HDD) or a solid state drive (SSD), in which digital data can be stored and rewritten. The controller 211 has a central processing unit (CPU) 212 and a memory 213, and the CPU 212 controls the overall operation of the client terminal 101 by loading programs stored in the storage section 214 into the memory 213 and executing the loaded programs. The memory 213 is a main storage memory for the CPU 212 and has a work area for loading a variety of programs and a temporary storage area for temporarily storing calculation data.

The network communication section 215 is an interface for transmitting and receiving a variety of data to and from an external apparatus, such as the printer 104 forming the printing system 100, via the network 105. The display section 216 is e.g. a liquid crystal display and presents visual information to a user. The operation section 217 is comprised of a keyboard, a mouse, and a touch panel which also functions as the display section 216, and receives an input from a user.

FIG. 2B is a block diagram showing the hardware configuration of the management server 102. The management server 102 includes a display section 226, an operation section 227, a storage section 224, a controller 221, and a network communication section 225, and the controller 221 has a CPU 222 and a memory 223. These components are the same as the corresponding components of the client terminal 101, and hence description thereof is omitted. In the following description, the management server 102 is formed by one information processing apparatus having the hardware configuration shown in FIG. 2B but can be formed by a plurality of information processing apparatuses.

FIG. 2C is a hardware block diagram showing details of the support server 103. The support server 103 includes a display section 236, an operation section 237, a storage section 234, a controller 231, and a network communication section 235, and the controller 231 has a CPU 232 and a memory 233. The display section 236, the operation section 237, and the controller 231 are the same as the display section 216, the operation section 217, and the controller 211 of the client terminal 101, and hence description thereof is omitted.

The storage section 234 is e.g. an HDD or an SSD and stores a file holding information for extending functions provided by the client terminal 101 (hereinafter referred to as the “extension setup information file”).

The network communication section 235 is an interface for performing communication with the client terminal 101. The support server 103 receives a request for acquiring the extension setup information file stored in the storage section 234 from the client terminal 101 via the network communication section 235 and transmits the requested extension setup information file to the client terminal 101. In the following description, the support server 103 is formed by one information processing apparatus having the hardware configuration shown in FIG. 2C but can be formed by a plurality of information processing apparatuses.

FIG. 2D is a block diagram showing the hardware configuration of the printer 104. In the present embodiment, the description will be given assuming that the printer 104 is a single function printer having only a print (image formation) function, but the printer 104 can be a multifunction peripheral (MFP) further having a scanner function and a FAX function.

The printer 104 includes a display section 246, an operation section 247, a storage section 244, a controller 241, a network communication section 245, and a printing section 248, and the controller 241 has a CPU 242 and a memory 243. The controller 241 is the same as the controller 211 of the client terminal 101 except that programs for controlling the overall operation of the printer 104 are stored in the memory 243, and hence description thereof is omitted.

The display section 246 is comprised of a touch panel that displays information to a user, a light emitting diode (LED), and so forth. The operation section 247 includes hard keys, such as a numeric key, and a touch panel that also functions as the display section 246 and receives an input from a user, and so forth.

The storage section 244 is e.g. an HDD or an SSD, and stores user information and print jobs, as well as a database 250 with which (to which) these information items are associated (related). The network communication section 245 is an interface for performing communication with the client terminal 101, and receives print data mainly from the client terminal 101 and further transmits printer information, such as information on an error having occurred in the printer 104, to the client terminal 101.

The printing section 248 performs a print (image formation) process by performing a series of processing operations of sheet feeding, printing, and sheet discharging, on a recording medium, such as a sheet accommodated in a cassette or placed on a tray. As the image forming method, there can be mentioned the electrophotographic method, the inkjet method, or the like, but this is not limitative. Note that the printing section 248 can have a double-sided printing unit used when discharging a sheet, and a finishing apparatus that performs stapling, punching, and so forth.

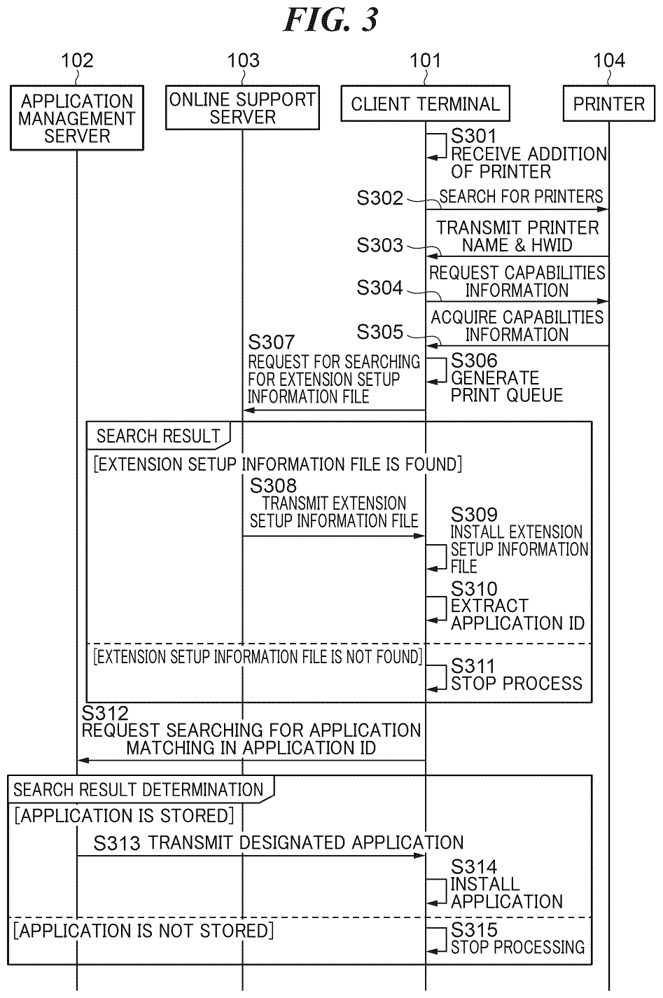

FIG. 3 is a sequence diagram for installing the print setting-extending application 112 in the client terminal 101. The process performed by the client terminal 101 appearing in the sequence diagram shown in FIG. 3 is executed by the controller 211 (CPU 212) operating on the OS 113 (according to a program of the OS 113). The processes performed by the management server 102, the support server 103, and the printer 104 are similarly realized by the respective controllers executing predetermined programs.

In a step S301, the controller 211 of the client terminal 101 receives a setup operation for the printer 104 (printer addition operation), which is performed by a user.

In a step S302, the controller 211 of the client terminal 101 searches for printers connected to the network 105 to which the client terminal 101 is connected, by using mDNS, Bonjour, or the like.

In a step S303, the controller 241 of the printer 104 transmits printer information to the client terminal 101 in response to the acquisition request. The printer information transmitted to the client terminal 101 in the step S303 refers to a printer name given to the printer 104 and a HWID (ID allocated to each model of the printer) which is device identification information. The controller 211 of the client terminal 101 displays the printer information detected by the search of the network 105 on the display section 216.

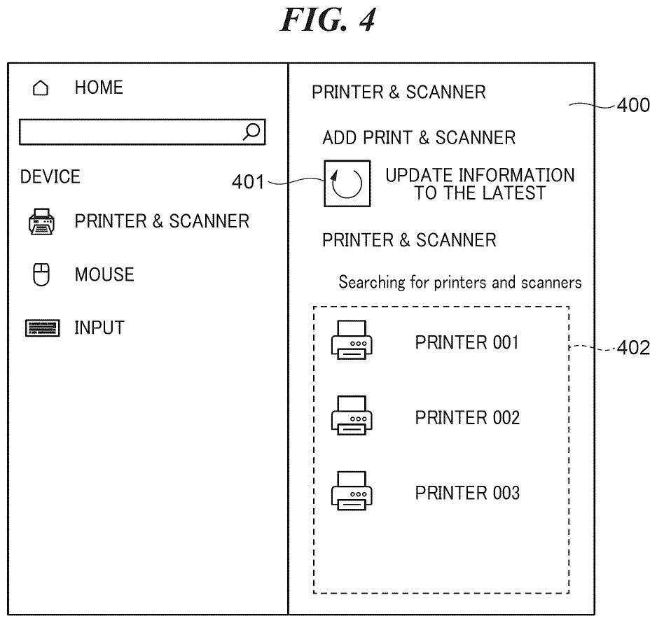

The description of the processing operations in the steps S301 to S303 will be supplemented with reference to FIG. 4. FIG. 4 shows an example of a screen that displays information concerning printers registered in the client terminal 101. A setting screen 400 for setting a printer and a scanner is displayed on the display section 216 of the client terminal 101 by a user's operation performed on the operation section 217. When the setup operation in the step S301 is performed by selecting an object 401 (icon) based on e.g. a touch operation, the controller 211 of the client terminal 101 receives the instruction for searching for printers in the step S302 and starts the printer search. In the step S303, the controller 211 of the client terminal 101 displays a list of information on printers and scanners, acquired by the search. In an area 402 of the setting screen 400, the detected printers and scanners are displayed in a list with names each e.g. in the form of “printer XXX”.

Referring again to FIG. 3, when it is detected that a specific device is selected from the printers and scanners displayed in the area 402 (based on a touch operation performed on a thumbnail or name displaying part of e.g. printer 001), the controller 211 of the client terminal 101 starts processing in a step S304. In the following description, it is assumed that a thumbnail corresponding to the printer 104 appearing in FIG. 1 has been selected from the devices displayed in the area 402.

In the step S304, the controller 211 of the client terminal 101 requests capabilities information to the selected printer 104. The capabilities information is information which represents functions equipped in the printer 104 and refers to information necessary for a user to set print conditions (such as double-sided print capability information and color printability information). Note that which setting item of the capabilities information is to be requested by the controller 211 of the client terminal 101 has been determined according to the specifications of the OS 113 in advance.

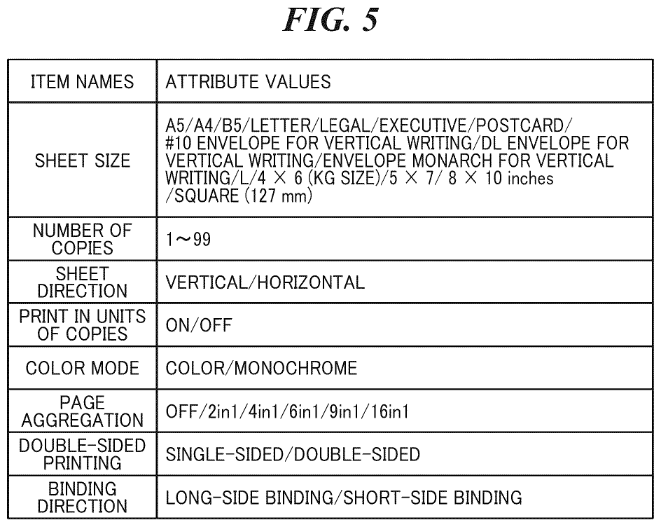

FIG. 5 is a diagram showing an example of the capabilities information held (stored) in the printer 104. The capabilities information is formed by “item name” and “attribute value”. The “item name” indicates a setting item of print conditions, and the “attribute value” indicates a value which can be set, an option, and a value range, for each setting item. Note that the printer 104 has stored setting items and attribute values (such as a sheet size, a color mode, and page aggregation) which are defined by the IPP as the industry-standard specification.

What kind of capabilities information is to be requested to the printer 104 by the controller 211 of the client terminal 101 is determined according to the OS 113, and has been set in the OS 113 in advance. Therefore, the controller 211 of the client terminal 101 designates setting items determined in advance, and requests capabilities information to the printer 104 for each setting item. In the present embodiment, it is assumed that acquisition of information concerning setting items defined by the IPP as the standard specification has been set in the OS 113 of the client terminal 101 in advance. The controller 211 of the client terminal 101 requests capabilities information concerning the setting items of “sheet size”, “sheet type”, and “color mode”, to the printer 104.

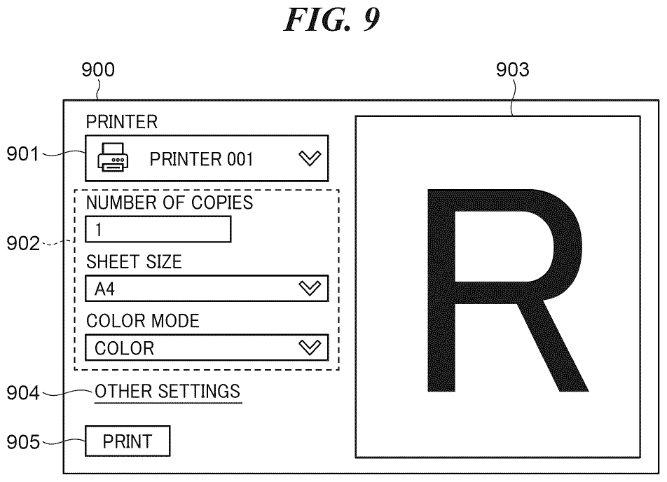

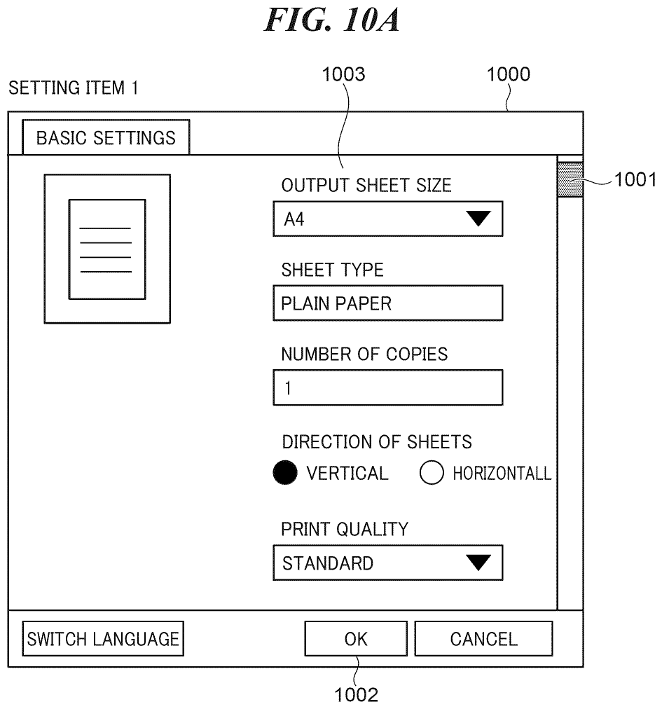

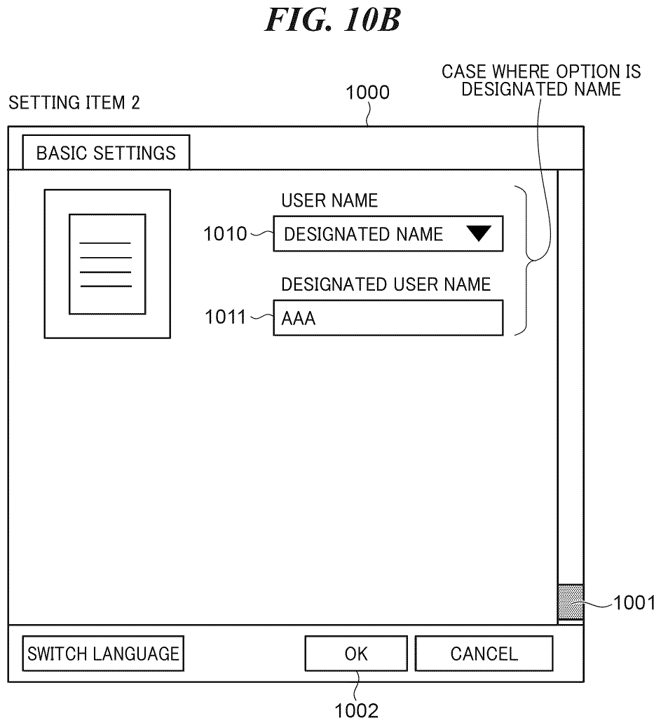

Referring again to FIG. 3, in a step S305, the controller 241 of the printer 104 transmits the capabilities information of the setting items to the client terminal 101 as a response to the request received in the step S304. At this time, the capabilities information of the setting items include attribute values and default values. The attribute values are all attribute values stored in the printer 104 regardless of whether or not each attribute value is an attribute value defined by the IPP as the standard specification. Further, the default values are values set first when the client terminal 101 displays the print setting screen (see FIGS. 9, 10A, and 10B). However, in a case where a request for a setting item whose attribute value has not been stored is received, the printer 104 does not respond to the client terminal 101 with respect to the setting item.

In a step S306, the controller 211 of the client terminal 101 starts installation of the local printer driver 111 based on the HWID and the printer name as the device identification information of the printer 104 selected by the user. Further, in the step S306, the controller 211 of the client terminal 101 generates a print queue of the local printer driver 111 having the basic device capabilities information included in the OS 113. The device capabilities information refers to definition information necessary to generate print setting capabilities information (information concerning a variety of conditions (parameters) which can be set when printing using the local printer driver 111 is performed) of the local printer driver 111. The device capabilities information is described in the XML, as in PrintDeviceCapabilities.

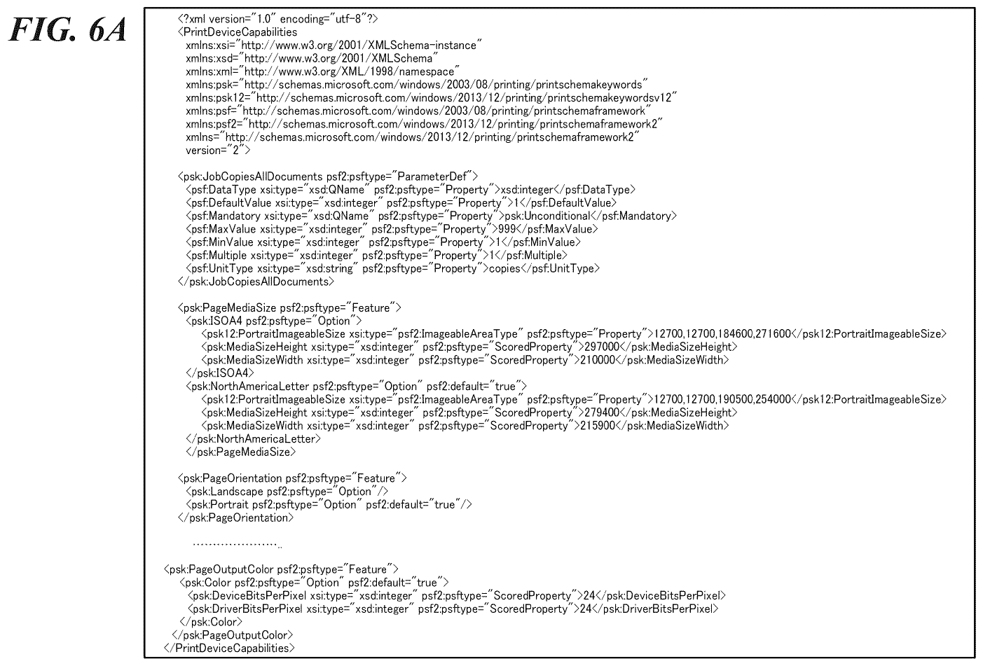

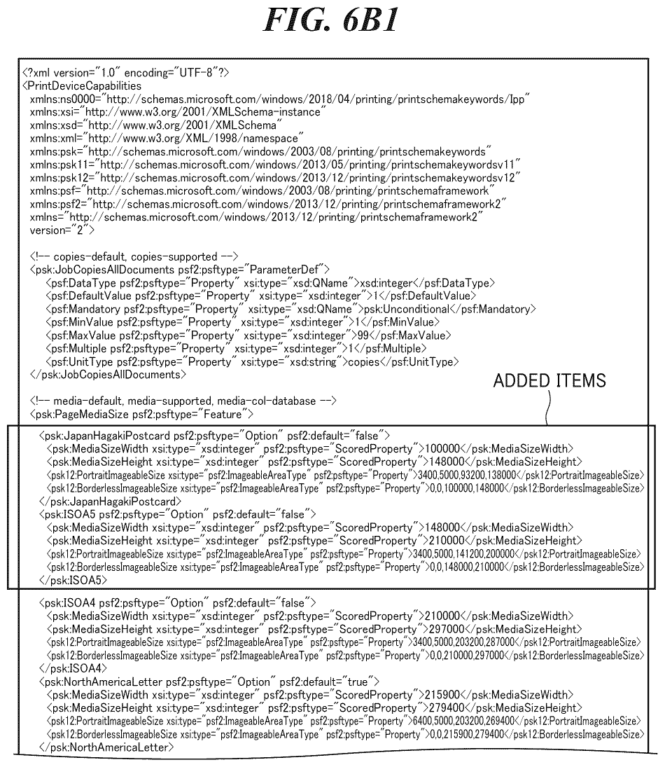

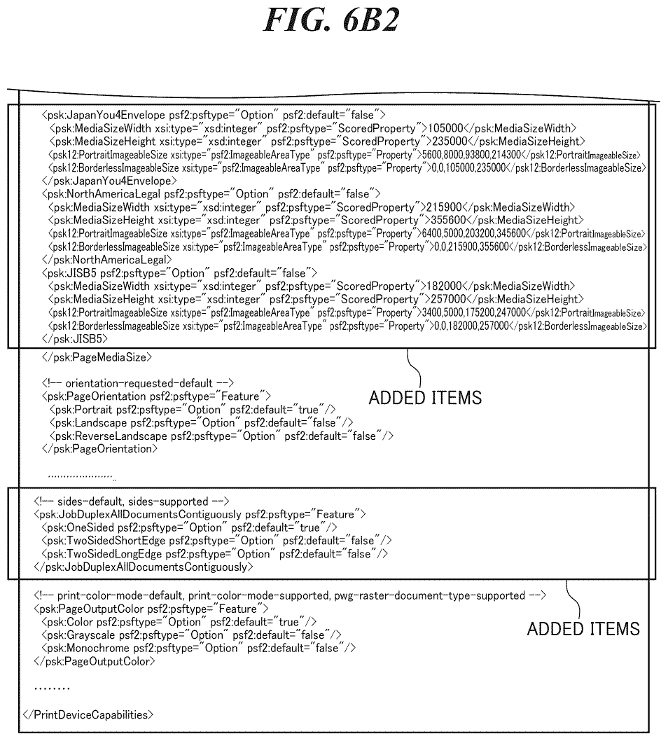

Details of the processing in the step S306 will be described. FIG. 6A is a diagram showing an example of the device capabilities information in the initial state, which is included in the OS 113 of the client terminal 101. For example, “Feature” indicates that “PageMediaSize” representing the sheet size is a setting item. “Option” indicates options associated with “PageMediaSize”. The device capabilities information in the initial state of the OS 113 has only two options of “A4” and “LETTER” as the sheet size as shown in FIG. 6A. These information items are stored in a state associated with the print queue of the local printer driver 111 and managed by the OS 113, when the print queue of the local printer driver 111 is generated. Note that the device capabilities information in the initial state is fixed information which is not related to the capabilities information of the connected printer 104.

The controller 211 of the client terminal 101 updates the device capabilities information held by the OS 113, using the capabilities information of each setting item, which is acquired from the printer 104. FIG. 6B1-6B2 is a diagram showing an example of the device capabilities information held by the OS 113, which has been updated in the client terminal 101, using the capabilities information acquired from the printer 104. For example, “Option” as a sheet size which can be printed by the printer 104 is added to “PageMediaSize” representing the sheet size.

Thus, the client terminal 101, first, associates the local printer driver 111 and the device capabilities information included in the OS 113 with each other and registers the device capabilities information in the print queue. Then, the client terminal 101 updates the device capabilities information associated with the print queue with the capabilities information acquired from the printer 104. At this time, in the OS 113, the device capabilities information is updated only with the attribute values defined by the industry-standard specification out of the capabilities information acquired from the printer 104. Therefore, even when the controller 211 of the client terminal 101 has acquired the attribute value of e.g. a sheet type, which is unique to the vendor, as the capabilities information of the printer 104, this attribute value is not added to the device capabilities information held by the OS 113.

As described above, it is possible to set print conditions of the client terminal 101, which cannot be set using the device capabilities information in the initial state, which is included in the OS 113.

Thus, installation of the local printer driver 111 is completed. By performing the process up to this step, it is possible to transmit print data from the client terminal 101 to the printer 104.

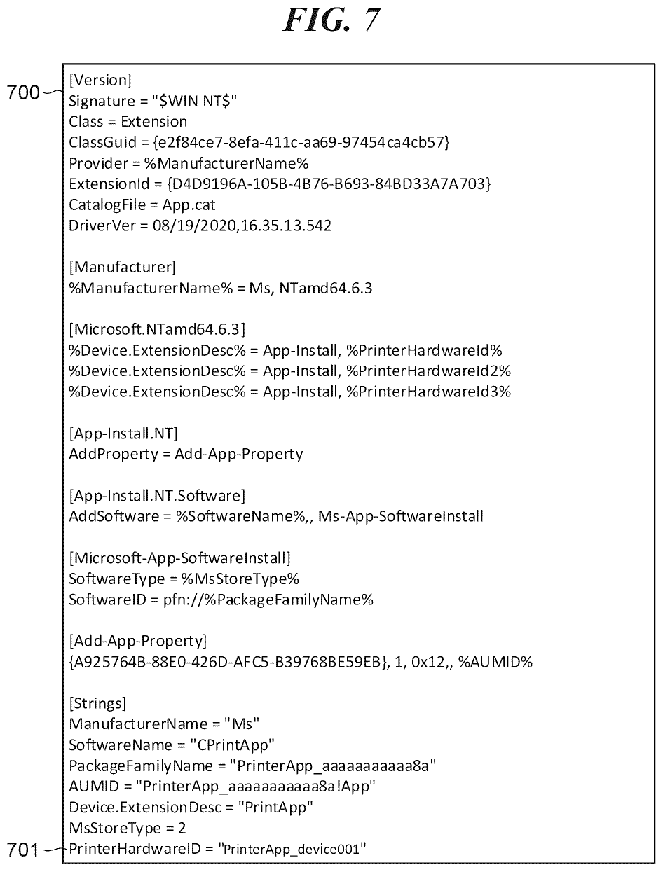

Then, the controller 211 of the client terminal 101 starts, on the OS 113, a process for installing an application which is associated with the printer 104 and extends functions of the local printer driver 111. First, the controller 211 performs processing for adding identification additional information to the device identification information acquired from the printer 104. This is processing necessary to acquire an extension setup information file 700 (see FIG. 7) from the support server 103, and the identification additional information is only required to be a character string different from the normal device identification information. In the present embodiment, with a view to distinguishing the application from applications for other devices, “PrinterApp_” is added to the device identification information as the identification additional information indicating that the application is associated with the printer. For example, in a case where the device identification information of the printer 104 is “device001”, the device identification information to which the identification additional information has been added (hereinafter referred to as the “additional information-added device identification information”) is expressed as “PrinterApp_device001”. The “PrinterApp_” is an example and can be formed by another character string, a number, and a symbol. The process up to this is performed in the step S306.

Next, in a step S307 in FIG. 3, the controller 211 of the client terminal 101 transmits a request for searching for the extension setup information file 700 including the additional information-added device identification information of the printer 104 to the support service 130. That is, in the step S307, “PrinterApp_device001” as the above-mentioned additional information-added device identification information is notified to the support server 103.

In the support service 130 held by the support server 103, a variety of extension setup information files are stored. FIG. 7 shows an example of the extension setup information file 700 for the printer 104. The extension setup information file 700 is generated by the vendor of the printer 104 and is registered in the support service 130. The extension setup information file 700 describes identification information for identifying the print setting-extending application 112 used for setting print data to be transmitted to the printer 104.

“PackageFamilyName” denoted by reference numeral 701 in the extension setup information file 700 is the identification information (application ID) of the print setting-extending application 112. “PrinterHardwareID” denoted by reference numeral 702 in the extension setup information file 700 describes a character string formed by adding the identification additional information to the identification information of the printer 104 is described.

The support service 130 stores not only the extension setup information file 700 in which identification information of the print setting-extending application 112 is described, but also an extension setup information file in which the identification information of the local printer driver 111 is described. In the extension setup information file in which the identification information of the local printer driver 111 is described, the item of “PackageFamilyName” describes an identifier of the local printer driver 11. Further, in the extension setup information file in which the identification information of the local printer driver 111 is described, the item of “PrinterHardwareID” describes device identification information in which the identification additional information is not described.

Thus, the support service 130 stores both of the extension setup information file in which the identifier of the print setting-extending application is described and the extension setup information file in which the identifier of the printer driver is described. Therefore, the controller 211 of the client terminal 101 adds the identification additional information to the device identification information in order to acquire the necessary extension setup information file, as required.

Referring again to FIG. 3, when the request transmitted in the step S307 is received, the controller 231 of the support server 103 searches the support service 130 for an extension setup information file matching in the additional information-added device identification information and “PackageFamilyName”. As a result, if the extension setup information file 700 satisfying the above-mentioned search conditions is found, in a step S308, the controller 231 of the support server 103 transmits the found extension setup information file 700 to the client terminal 101 as a response. With this, it is possible to write the contents of the extension setup information file 700 in the registry of the OS 113 of the client terminal 101.

In a step S309, the controller 211 of the client terminal 101 installs the extension setup information described in the extension setup information file 700 acquired from the support service 130, in a state associated with the print queue generated in the step S306.

In a step S310, the controller 211 of the client terminal 101 extracts an application ID from the installed extension setup information. The application ID is specified by “PackageFamilyName” in the extension setup information file 700.

The process up to this step is a process performed in a case where the extension setup information file associated with the printer 104 is stored in the support service 130.

On the other hand, there is a case where the controller 231 of the support server 103 cannot find an extension setup information file matching in the additional information-added device identification information and “PackageFamilyName” from the support service 130. In this case, in a step S311, the controller 211 of the client terminal 101 stops the process for installing the application for extending the functions of the local printer driver 111. The controller 211 of the client terminal 101 executes the step S311 in a case where no extension setup information file can be received within a predetermined time period from transmission of the search request in the step S307 or in a case where an error notification is received from the support server 103.

In a step S312 et seq., a process performed in a case where the controller 211 of the client terminal 101 has acquired the extension setup information file 700, and extraction of the application ID is successfully performed in the step S310 will be described.

In the step S312, the controller 211 of the client terminal 101 requests the management server 102 to search for an application matching in the extracted application ID (specifically, the print setting-extending application 112).

Here, let it be assumed that the application operating on the client terminal 101 and its application ID have been registered in the management service 120 by the vendor that provides the printer 104, in advance. Further, in the present embodiment, it is assumed that the management service 120 held by the management server 102 stores the print setting-extending application 112 operating on the client terminal 101 and the application ID as its identifier in a state associated with each other. Therefore, upon receipt of the search request in the step S312, the controller 221 of the management server 102 checks whether or not the print setting-extending application 112 is held as an application matching in the application ID, which is requested from the client terminal 101.

Note that in a case where the management service 120 does not hold an application (the print setting-extending application 112) matching in the application ID requested in the step S312, the controller 211 of the client terminal 101 stops the application installation processing in a step S315. In this case, in the client terminal 101, the generated print queue and the local printer driver 111 are associated and installed, followed by terminating all the processes.

In a step S313, in a case where it is detected that the requested print setting-extending application 112 is held by the management service 120, the controller 221 of the management server 102 transmits the detected print setting-extending application 112 to the client terminal 101.

In a step S314, the controller 211 of the client terminal 101 installs the print setting-extending application 112 acquired from the management server 102 in a state associated with the print queue of the client terminal 101. In the step S314, further, the controller 211 stores the application ID in a predetermined registry of the OS 113 as the information on the print queue. Note that the print setting-extending application 112 is installed on a user-by-user basis, and hence the processing for associating the print setting-extending application 112 with the local printer driver 111 is required on a user-by-user basis.

Further, in the step S314, the controller 211 performs setting for the OS 113 such that event notification is performed at a timing when the print queue associated with the print setting-extending application 112 is set on the print setting screen, and this terminates the present sequence.

With the above-described process, when the client terminal 101 is powered on to start the OS 113, it is possible to start the print setting-extending application 112 installed in the client terminal 101 and cause the print setting-extending application 112 to operate as a background task.

Note that in the above description, the predetermined character string is added to the device identification information of the printer 104, and the extension setup information file is searched for. This is not limitative, but in a case where it is possible to determine whether or not a file is one which can be applied to the local printer driver 111, the search can be performed without adding the predetermined character string.

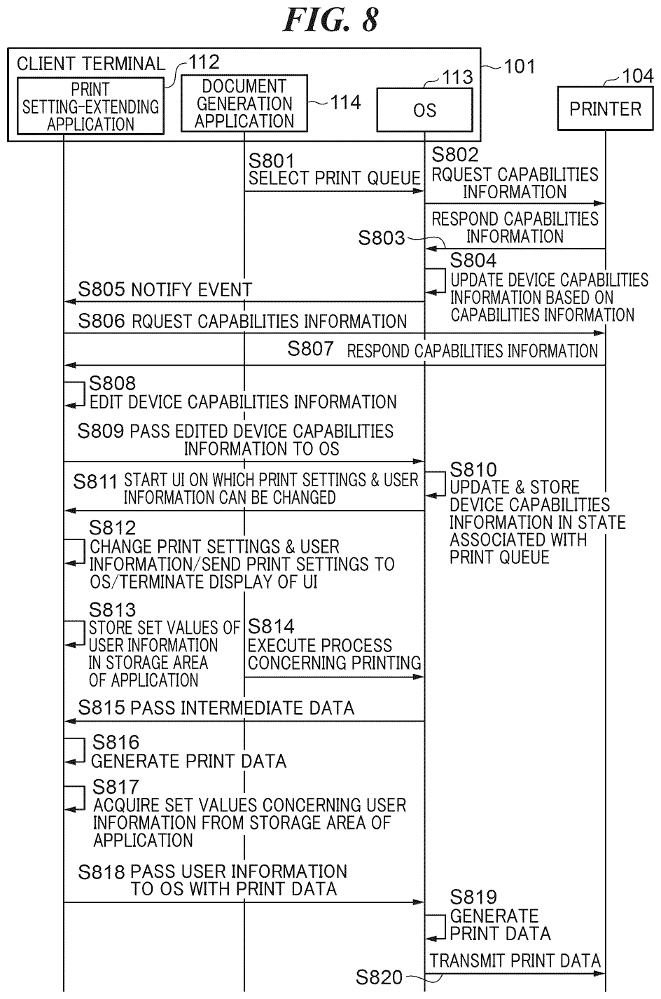

Next, a process performed by the client terminal 101 of the printing system 100, for transmitting print data to the printer 104 will be described. FIG. 8 is a sequence diagram of the process performed by the client terminal 101, for transmitting print data to the printer 104. The processing operations (steps) each denoted by S number in the sequence diagram are realized by the controller 211 (CPU 212) that executes the print setting-extending application 112, the OS 113, and the document generation application 114, at any time required.

Before starting a step S801, the user of the client terminal 101 starts the document generation application 114 to display a print setting screen for selecting a print queue, on the display section 216, by the document generation application 114. Note that the document generation application 114 is any of an application for generating a document or a presentation material, and an application for displaying and editing a photograph, an image, or the like.

FIG. 9 is a diagram showing an example of a print setting screen 900. On the print setting screen 900, an object 901 for selecting a print queue, an object 902 for making print settings, and a print preview image 903 are displayed. Further, an object 904 for displaying a user interface (UI) of the print setting-extending application 112 and an object 905 for executing printing are displayed. Note that although in the present embodiment, the controller 211 displays the print setting screen 900 by using the document generation application 114, the same screen can be displayed by the OS 113.

Referring to the step S801, the controller 211 selects a print queue associated with a printer set as a default printer, by the document generation application 114, and displays the selected print queue in the object 901 on the print setting screen 900 in FIG. 9. Here, it is be assumed that the printer 001 is selected as the default printer. Note that the step S801 et seq. are also executed in a case where the user changes a printer to be used, by operating the object 901.

In a step S802, the controller 211 inquires about the capabilities information of the printer 104 in the print queue associated with the printer 104. At this time, as to which setting item the capabilities information is inquired after is determined in advance according to the specifications of the OS 113. Therefore, the capabilities information acquired in the step S802 is the same as that acquired in the step S305 in the sequence shown in FIG. 3. The request to the printer 104 in the step S802 is performed by using a command of a standard protocol defined by the IPP, such as “Get-printer-Attributes”. In a case where “Get-printer-Attributes (IPP)” is used, the controller 211 requests the capabilities information determined by the OS 113 in a list form.

In a step S803, the controller 241 of the printer 104 transmits the capabilities information of the printer 104 corresponding to the list of the capabilities information, which has been transmitted from the client terminal 101, to the client terminal 101 as a response. For example, in a case where the attribute of an output sheet size is designated by “Get-printer-Attributes (IPP)”, if the attribute of the output sheet size is held, the controller 241 of the printer 104 transmits values (such as A4, B5, and Letter) associated with this attribute as a response. If no attribute designated by “Get-printer-Attributes (IPP)” is held by the printer 104, the controller 241 of the printer 104 does not transmit values associated with this attribute as a response. In other words, as to the capabilities information requested from the client terminal 101 in the step S802, the type and capabilities of the printer 104 connected to the client terminal 101 are ignored.

In a step S804, the OS 113 causes the controller 211 of the client terminal 101 to update the device capabilities information with the capabilities information acquired from the printer 104. That is, the controller 211 adds the capabilities information acquired in the step S803 to the device capabilities information generated in the step S306 (see FIG. 3). By executing the step S803, in a case where the device capabilities information has been updated in the printer 104, it is possible to update the device capabilities information managed by the client terminal 101. Not that in the update of the device capabilities information in the step S804, the device capabilities information is updated only with respect to the attribute values defined by the industry-standard specification.

In a step S805, the OS 113 causes the controller 211 of the client terminal 101 to notify the print setting-extending application 112 of an application programing interface (API) used for editing an event and the device capabilities information. The timing of this notification is registered when the print setting-extending application 112 is installed in the client terminal 101.

In a step S806, the print setting-extending application 112 causes the controller 211 of the client terminal 101 to transmit a request for acquiring the capabilities information to the printer 104. In this step, the capabilities information for writing the setting items, the attribute values, and so forth, which are uniquely defined by the vendor of the printer 104 into the device capabilities information held by the OS 113 is requested, similar to the step S802, by using “Get-printer-Attributes (IPP)”. Note that in the step S806, not only the setting items, the attribute values, and so forth, which are uniquely defined by the vendor of the printer 104, but also the capabilities information with respect to setting items already acquired by the OS 113 can be acquired.

In a step S807, the controller 241 of the printer 104 transmits the capabilities information requested in the step S806 (the setting items, the attribute values, and so forth, which are uniquely defined by the vendor of the printer 104) to the client terminal 101 as a response. The method of transmitting the response in this step is the same as the above-described method in the step S305 in FIG. 3, and hence description thereof is omitted.

In a step S808, the print setting-extending application 112 causes the controller 211 of the client terminal 101 to perform processing for editing the capabilities information acquired in the step S807 into device capabilities information which can be managed by the OS 113 via a configuration information object. Here, the configuration information object refers to a set of a data group necessary to edit the device capabilities information. The print setting-extending application 112 cannot directly edit the device capabilities information held by the OS 113, and hence the print setting-extending application 112 updates the device capabilities information held by the OS 113 by using the configuration information object.

By executing the process up to the step S808, not only the capabilities information concerning standard setting items in response to the request by the OS 113, but also the setting items and the attribute values unique to the vendor of the printer 104, in response to the request by the print setting-extending application 112, are acquired as the device capabilities information.

In a step S809, the print setting-extending application 112 causes the controller 211 of the client terminal 101 to pass the device capabilities information edited in the step S808 to the OS 113.

In a step S810, the OS 113 causes the controller 211 of the client terminal 101 to update the device capabilities information and store the updated device capabilities information in a state associated with the print queue. With this, the object 904 as a trigger for displaying the UI (extended print setting screen) of the print setting-extending application 112 is made selectable on the print setting screen 900 in FIG. 9. Note that the object 904 is grayed out until the processing in the step S810 is completed, and even when the user selects the object 904, the screen is not shifted to the extended print setting screen. When the processing in the step S810 is completed, the object 904 is released from the grayed-out state, and the user is enabled to select the object 904.

When the user selects the object 904, in a step S811, the controller 211 of the client terminal 101 starts the print setting-extending application 112 to display the extended print setting screen on the display section 216. Here, the extended print setting screen is generated based on the print setting capabilities information of the local printer driver 111, which is acquired from the OS 113 by the print setting-extending application 112, without depending on a type of the document generation application 114 used.

FIG. 10A is a diagram showing an example of the extended print setting screen. An extended print setting screen 1000 includes a scroll bar 1001 and can be shifted to the display shown in FIG. 10B by operating the scroll bar 1001 to scroll the screen. Thus, it is possible to set values for a variety of items.

An output sheet size of setting items 1003 is the print setting information generated from “psk: PageMediaSize” in FIG. 6B1-6B2. The print setting-extending application 112 causes the controller 211 to generate and display an option “A4” of the output sheet size based on the print setting information “psk: IOSA4”. Thus, the print setting-extending application 112 causes the controller 211 to convert the values of the device capabilities information to the set values and display the set values on the extended print setting screen 1000.

The extended print setting screen 1000 is generated, by using the device capabilities information including the capabilities information concerning the setting items specific to the vendor of the printer 104. Therefore, on the extended print setting screen 1000, it is possible to set a value for an item which cannot be set on the print setting screen 900 (see FIG. 9) provided by the OS 113. For example, in a case where the user has changed the output sheet size from “A4” to “Letter” on the extended print setting screen 1000, the print setting-extending application 112 changes “A4” to “Letter” in the print setting information.

On the extended print setting screen 1000, separately from the print setting information, objects 1010 and 1011 for inputting the user information are displayed as shown in FIG. 10B. The object 1010 provides user information options for setting a user name. The print setting-extending application 112 has definition data which makes it possible to set “login name” or “computer name” (neither of which is shown) or “designated name” as the user name. The controller 211 prompts the user to input “login name”, “computer name” or “designated name” from the object 1010 on the print setting-extending application 112. Note that the login name is a name used by the user when logging into the client terminal 101, and the computer name is a name for identifying the client terminal 101. In a case where the designated name is designated in the object 1010, an input to the object 1011 in which a desired character string can be input is enabled, whereby the user can input a desired character string (name) in the object 1011 as the user name. FIG. 10B shows an example in which “AAA” is input in the object 1011 as the user name, and it is assumed that this “AAA” is the same as the user name used by the user to log into the printer 104.

On the extended print setting screen 1000, an object 1002 for finally determining the print settings is displayed. Note that in a case where the object 1002 is selected in a state in which no name is input in the object 1011 although the designated name is selected in the object 1010, the controller 211 displays e.g. a warning screen as the popup display. For example, on the popup screen displayed at this time, such a notification as “Input the user name” is provided to the user.

When the user selects the object 1002 (by performing a touch operation), processing operations in S812 and S813 in FIG. 8 are executed. The processing in the step S812 and the processing in the step S813 are practically executed at the same time, and which of these steps is executed first does not matter.

In the step S812, the print setting-extending application 112 causes the controller 211 of the client terminal 101 to pass the print setting information to the OS 113, and terminate the display of the extended print setting screen 1000. However, the user information is not included in the print setting information, and hence the user information is not sent to the OS 113. In the step S813, the controller 211 stores the set values of the user information (the values input to the objects 1010 and 1011) in a storage area which can be accessed only by the print setting-extending application 112. When the processing in the step S813 is terminated, the print setting screen 900 shown in FIG. 9 is displayed again. The print setting screen 900 displayed at this time is a screen on which the set values set on the extended print setting screen 1000 are reflected.

When the user selects the object 905 on the print setting screen 900, in a step S814, the OS 113 causes the controller 211 of the client terminal 101 to execute the process concerning printing based on an instruction input via the document generation application 114.

In a step S815, the OS 113 causes the controller 211 to generate intermediate data and pass the generated intermediate data to the print setting-extending application 112. The intermediate data is data generated before converted to print data, such as page description language (PDL) data, and one example of which is XML Paper Specification (XPS) data. The intermediate data includes the pint setting information set on the print setting screen 900 shown in FIG. 9. Note that a print job name is added to the intermediate data. As the print job name, a name of a document opened (e.g. being edited) when the processing in the step S801 is executed by the document generation application 114 is normally used.

In a step S816, the print setting-extending application 112 causes the controller 211 to generate print data based on the intermediate data and generate print capabilities information based on the print setting information. The print data refers to e.g. PDL data, such as a portable document format (PDF) file. Further, the print capabilities information specifically refers to information in which the print setting information is described using attribute values defined by the IPP.

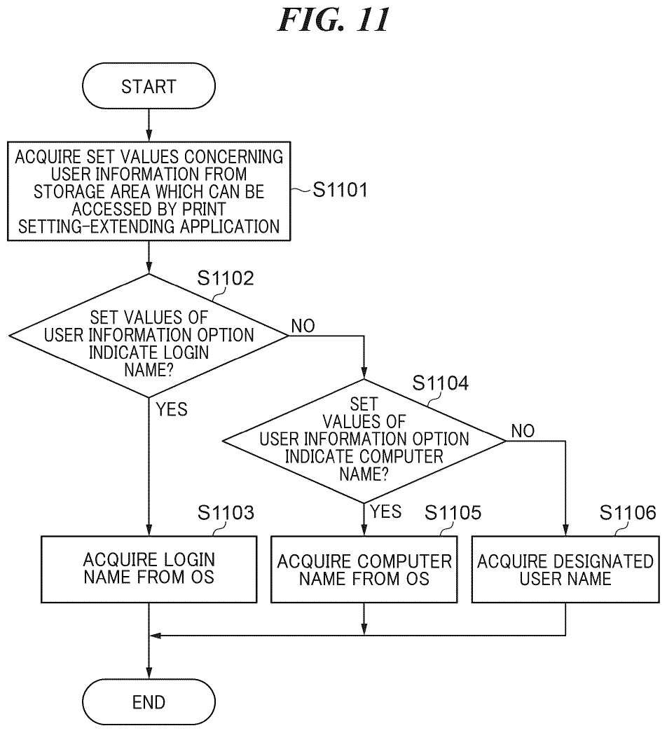

In a step S817, the print setting-extending application 112 causes the controller 211 to acquire the set values concerning the user information from the storage area which can be accessed only by the print setting-extending application 112. Here, a process in the step S817 will be described. FIG. 11 is a flowchart of the process performed in the step S817. The processing operations (steps) each denoted by S number in this flowchart are executed by the controller 211 on the print setting-extending application 112.

In a step S1101, the controller 211 acquires the set values concerning the user information from the storage area which can be accessed only by the print setting-extending application 112. In a step S1102, the controller 211 determines whether or not the set values of the user information option (object 1010 in FIG. 10B) acquired in the step S1101 indicate the login name. If it is determined that the set values indicate the login name (YES to the step S1102), the controller 211 executes a step S1103, whereas if it is determined that the set values do not indicate the login name (NO to the step S1102), the controller 211 executes a step S1104.

In the step S1103, the controller 211 acquires the login name via the API provided by the OS 113, followed by terminating the present process.

In the step S1104, controller 211 determines whether or not the set values of the user information option indicate the computer name. If it is determined that the set values indicate the computer name (YES to the step S1104), the controller 211 executes a step S1105, whereas if it is determined that the set values do not indicate the computer name (NO to the step S1104), the controller 211 executes a step S1106.

In the step S1105, the controller 211 acquires the computer name via the API provided by the OS 113, followed by terminating the present process.

In the step S1106, the controller 211 determines that the set values of the user information option indicate the designated name and acquires the value of the object 1011 in FIG. 10B, followed by terminating the present process.

Note that in the present embodiment, the value of the login name or the computer name is acquired from the OS 113 in the step S817. This is not limitative, but the values of the login name and the computer name can be acquired from the OS 113 in the step S813 and stored as the user information, and the step S817 can be executed by using the stored values. Further, in a case where the object 1011 is blank although the designated name is selected in the object 1010 in FIG. 10B, the warning screen is displayed as the popup display, as mentioned hereinabove. Without providing this function, if, in the same case, the processing in the step S817 in FIG. 8 proceeds to the step S1106 in FIG. 11, a screen for prompting a user to input a user name designated by the user can be separately displayed at the time.

In a step S818, the print setting-extending application 112 causes the controller 211 to generate print data and pass the generated print data, the print capabilities information, and the user information acquired in the step S817, to the print queue of the OS 113. Specifically, the controller 211 passes the information to the OS 113 by using an API which can add an IPP attribute. In the present embodiment, as the user information, the information of the user name, which is acquired in the step S817, is set for the attribute of “requesting-user-name” of “OperationAttribute”. For example, on the extended print setting screen 1000 shown in FIGS. 10A and 10B, the designated name is selected in the object 1010, and “AAA” is input to the object 1011 as the user name. In this case, the attribute value to be sent to the OS 113 is “requesting-user-name: AAA” of “OperationAttribute”.

In a step S819, the OS 113 causes the controller 211 to correct the print data received from the print setting-extending application 112 and generate print data suitable for the printer 104.

In a step S820, the OS 113 causes the controller 211 to transmit the print data generated by the OS 113 in the step S819 and the print capabilities information including the user information to the printer 104 via the print queue.

By executing the above-described series of the step S801 to S820, it is possible to transmit the print settings set by the print setting-extending application 112, the user information, and the generated print data (adjusted print data in a case where adjustment performed by the OS 113 is required) to the printer 104.

Next, processing and operations executed by the printer 104 will be described. The printer 104 receives the print data including the print settings and the user information from the client terminal 101 and registers the received print data in the database 250 appearing in FIG. 2D.

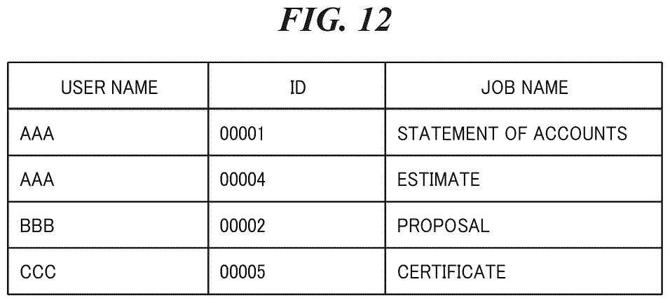

FIG. 12 is a diagram showing an example of a registration state of print jobs in the database 250. The database 250 shows print jobs transmitted to the printer 104 by the users “AAA”, “BBB”, and “CCC”, each after designating the user name in the objects 1010 and 1011 in FIG. 10B, according to the sequence shown in FIG. 8. Here, each print job is identified based on a user name and an ID. Note that the ID is information held by the printer 104 in the database 250 in a state associated with the user name. Here, although the print job is managed in a state associated with the user name, information other than the user name can be used insofar as it is possible to associate a print job and a user.

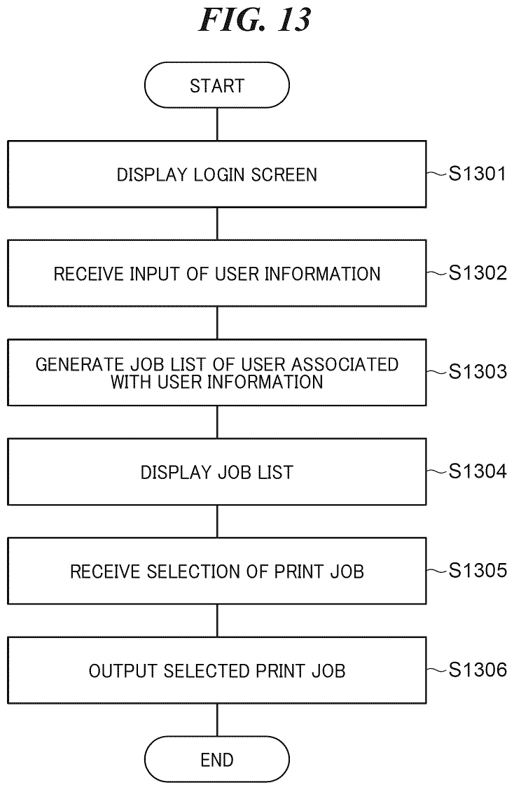

FIG. 13 is a flowchart of the print process performed by the printer 104. The processing operations (steps) each denoted by S number in this flowchart are realized by the CPU 242 of the controller 241 that performs centralized control of the operations of the components of the printer 104 by executing a program stored in the memory 243.

In a step S1301, the controller 241 displays a login screen on the display section 246 and waits for an input from the user.

In a step S1302, the controller 241 receives an input of the user information from the user on the login screen.

In a step S1303, the controller 241 extracts print jobs associated with the user information received in the step S1302 from the print jobs stored in the database 250 and generates a job list. Here, it is assumed that the user has input the user name “AAA” in the step S1302 as the user information.

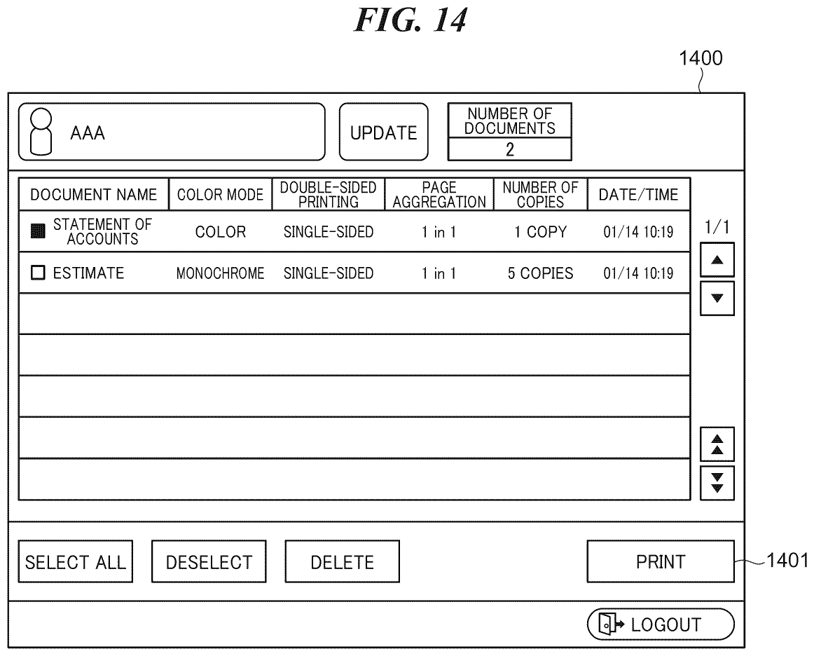

In a step S1304, the controller 241 displays the job list generated in the step S1303 on the display section 246. FIG. 14 is a diagram showing the job list, denoted by reference numeral 1400, which is displayed on the display section 246 in the step S1304. Here, as already shown in FIG. 12, the database 250 stores a print job associated with the user name “BBB” and a print job associated with the user name “CCC”, and two print jobs associated with the user name “AAA”, which have respective job names of “statement of accounts” and “estimate”. The job list 1400 displays only the print jobs associated with the user name “AAA” so as to prevent the print jobs of a user having logged in the printer 104 from being viewed by other users, and with this, it is possible to obtain high security with respect to the print jobs. The user can select a print job to be printed from the print jobs displayed in the job list 1400.

In a step S1305, the controller 241 receives execution of the print job selected by the user from the job list 1400. For example, the user selects “statement of accounts” on the job list 1400 and presses (selects) an object 1401. With this, printing of the statement of accounts is instructed to the controller 241.

In a step S1306, the controller 241 executes outputting of the instructed print job (printing on a recording material, such as a sheet (image formation process)), followed by terminating the present process.

As described above, according to the present embodiment, by transmitting the print data including the print setting information and the user name information from the OS of the client terminal to the printer by using the print setting-extending application, it is possible to properly manage jobs on a user-by-user basis, in the printer.

Next, a second embodiment of the present invention will be described. In the second embodiment, print data generated by the print setting-extending application in the client terminal is associated with a cloud printer driver used in a print service provided by a cloud server. In this case, the user management is performed in the cloud server, and hence transmission of the user information from the client terminal to the cloud server (printer connected to the cloud server) is not required, and therefore, it is unnecessary to prompt a user to input user information on a UI (extended print setting screen) of the client terminal.

Here, a description will be given of control for inputting user information, which is performed by the print setting-extending application 112. Note that the configuration of the printing system is the same as described in the first embodiment, and hence description thereof is omitted.

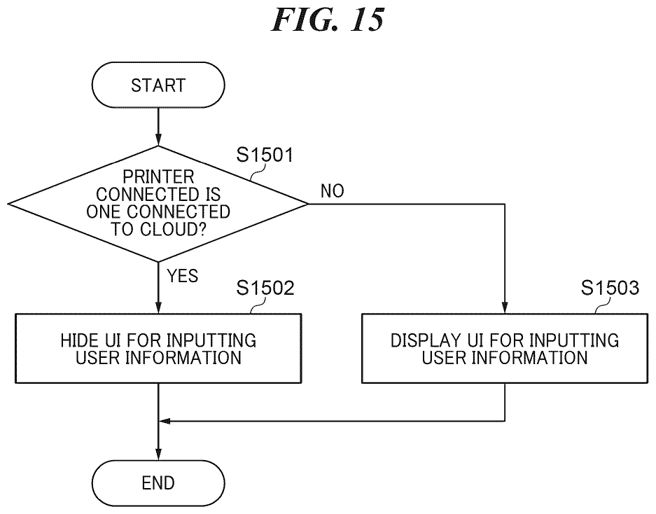

FIG. 15 is a process performed when starting the UI on which print settings and user information can be changed in the step S811 in FIG. 8. When the object 904 in FIG. 9 for displaying the UI of the print setting-extending application 112 is made selectable by the user in the step S810, processing in a step S1501 is started.

In the step S1501, the controller 211 of the client terminal 101 determines whether or not a printer connected from the print setting-extending application 112 is a printer connected to the cloud. For this determination, the API provided by the OS 113 can be used, or information on the printer, which can be acquired only in a case where the printer is connected to the cloud server, can be used. If it is determined that the printer is a printer connected to the cloud (YES to the step S1501), the controller 211 executes a step S1502, whereas if it is determined that the printer is not a printer connected to the cloud (NO to the step S1501), the controller 211 executes a step S1503.

In the step S1502, the controller 211 of the client terminal 101 displays the extended print setting screen (not shown), on which the objects 1010 and 1011 (see FIG. 10B) for inputting the user information are not displayed, on the display section 216, followed by terminating the present process. Note that the extended print setting screen displayed on the display section 216 in the step S1502 is a screen on which the objects 1010 and 1011 are hidden from the extended print setting screen 1000 shown in FIG. 10B or inhibited from being selected.

In the step S1503, the controller 211 of the client terminal 101 displays the extended print setting screen 1000 in FIG. 10B, on which the objects 1010 and 1011 for inputting the user information are displayed, on the display section 216, followed by terminating the present process. With this, the user is required to input the user information from the extended print setting screen 1000 only in a case where the input of the user information is required, and is prevented from being confused with respect to whether or not it is necessary to input the user information.

The present invention has been described heretofore based on the preferred embodiments thereof. However, the present invention is not limited to these embodiments, but it is to be understood that the invention includes various forms within the scope of the gist of the present invention. Further, the embodiments of the present invention are described only by way of example, and it is possible to combine the embodiments on an as needed basis.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-194301 filed Nov. 15, 2023, which is hereby incorporated by reference herein in its entirety.

What is claimed is:

1. An information processing apparatus, comprising:
at least one processor; and
a memory coupled to the at least one processor storing instructions that, when executed by the processor, cause the processor to function as:
a setting unit configured to set user information required by an image forming apparatus which is communicably connected directly or via a cloud;
a storage unit configured to store user information set by the setting unit;
a generation unit configured to generate print data for executing a print job in the image forming apparatus;
an acquisition unit configured to acquire the user information from the storage unit when the print job is executed by the image forming apparatus; and
a transmission unit configured to transmit the print data and the user information acquired by the acquisition unit to the image forming apparatus.

2. The information processing apparatus according to claim 1, further comprising a display unit, and
wherein the setting unit displays a user interface on which the user information can be input, on the display unit, and
wherein as the user information, the user interface receives an input of information required when a user logs into the image forming apparatus to execute a print job which is transmitted from the information processing apparatus to the image forming apparatus by the user having logged in the information processing apparatus and is stored in the image forming apparatus.

3. The information processing apparatus according to claim 2, wherein as the user information, one of a login name of the user, which is used with respect to the information processing apparatus, a name of the information processing apparatus, and a desired character string input by a user can be set via the user interface.

4. The information processing apparatus according to claim 3, wherein the processor is caused to further function as a determination unit configured to determine whether or not the image forming apparatus is connected to the information processing apparatus directly or via a cloud, and
wherein when displaying the user interface on the display unit, in a case where it is determined by the determination unit that the image forming apparatus is directly connected to the information processing apparatus, the setting unit displays an object for inputting the user information on the user interface, whereas in a case where it is determined by the determination unit that the image forming apparatus is connected to the information processing apparatus via the cloud, the setting unit does not display the object on the user interface or displays the object in a state inhibiting input from the object.

5. The information processing apparatus according to claim 2, wherein the user interface also functions as a user interface for making print settings when the print job is executed by the image forming apparatus.

6. A method of controlling an information processing apparatus communicably connected to an image forming apparatus directly or via a cloud, comprising:
setting user information required by the image forming apparatus;
storing the user information in a storage unit;
generating print data associated with a print job to be executed by the image forming apparatus;
acquiring the user information from the storage unit; and
transmitting the print data and the user information to the image forming apparatus.

7. The method according to claim 6, further comprising:
determining whether or not the image forming apparatus is connected to the information processing apparatus directly or via a cloud; and
displaying a user interface on which the user information can be input on a display unit included in the information processing apparatus,
wherein the setting includes setting a value input on the user interface as the user information, and
wherein the displaying includes displaying an object for inputting the user information in a case where it is determined that the image forming apparatus is directly connected to the information processing apparatus, and not displaying the object or displaying the object in a state inhibiting input from the object in a case where it is determined that the image forming apparatus is connected to the information processing apparatus via the cloud.

8. A non-transitory computer-readable storage medium storing a program for causing a computer to execute a method of controlling an information processing apparatus communicably connected to an image forming apparatus directly or via a cloud,
wherein the method comprises
setting user information required by the image forming apparatus;
storing the user information in a storage unit;
generating print data associated with a print job to be executed by the image forming apparatus;
acquiring the user information from the storage unit; and
transmitting the print data and the user information to the image forming apparatus.

9. The non-transitory computer-readable storage medium according to claim 8,
wherein the method further comprises:
determining whether or not the image forming apparatus is connected to the information processing apparatus directly or via a cloud; and
displaying a user interface on which the user information can be input on a display unit included in the information processing apparatus,
wherein the setting includes setting a value input on the user interface as the user information, and
wherein the displaying includes displaying an object for inputting the user information in a case where it is determined that the image forming apparatus is directly connected to the information processing apparatus, and not displaying the object or displaying the object in a state inhibiting input from the object in a case where it is determined that the image forming apparatus is connected to the information processing apparatus via the cloud.
